(19) United States
(12) Patent Application Publication
(10) Pub. No.: US 2004/0116543 A1
(43) Pub. Date: Jun. 17, 2004

(54) Hydroxypatite dispersions comprising a stabilising agent with a phosphoryl, sulphinyl or carboxyl functional , and method for preparing same

(76) Inventors: Jean-Yves Chane-Ching, Eaubonne (FR); Claude Magnier, Paris (FR); Marc Airiau, Rueil-Malmaison (FR)

Correspondence Address: BURNS DOANE SWECKER & MATHIS L L P, POST OFFICE BOX 1404, ALEXANDRIA, VA, 22313-1404, US

(21) Appl. No.: 10/475,294

(22) PCT Filed: Apr. 25, 2002
(86) PCT No.: PCT/FR02/01442

(30) Foreign Application Priority Data
Apr. 27, 2001 (FR) 01/05746

(51) Int. Cl. B01F 17/00

(52) U.S. Cl. 516/77

(57) ABSTRACT

The invention concerns a stable aqueous colloidal dispersion with apatite structure, having a pH ranging between 3.5 and 9,5, oblong-shaped with average length between 20 and 200 nm and an equivalent aspect ratio (average length/equivalent diameter ratio) between 5 and 500, and comprising as stabilising agent a compound of formula (I), a compound of formula (II) or a compound of formula (III), such as defined below, optionally in ionized form, or a mixture of said compounds, said colloids with apatite structure corresponding to formula (IV): Ca₁₀₋ₓ(HPO₄)ₓ(PO₄)₆₋ₓ(J)₂₋ₓ, wherein x and J are such as defined in claim 1, the stabilising agents corresponding to formula (I), wherein p, X, G₁, n, R and m are such as defined in claim 1; the stabilising agents corresponding to formula (II), wherein A, X′″, K, n′ and R′ are such as defined in claim 1; the stabilising agents corresponding to formula (III), wherein X, G₁, n and R are such as described in claim 1.

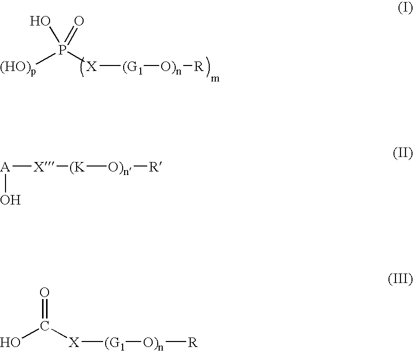

The present invention relates to stable aqueous colloidal dispersions of colloids possessing an apatite structure in which the colloids, of oblong shape, exhibit nanometric dimensions.

These colloids, in the more or less aggregated form, form objects of oblong shape with a (number-)average length (or greater dimension) of between 20 and 200 nm and with an equivalent aspect ratio of between 5 and 500.

The term “aqueous colloidal dispersion” is generally understood to mean a system composed of a continuous aqueous phase in which fine solid particles of colloidal size are dispersed, said fine particles defining colloids at the surface of which molecules of a stabilizing agent or various ionic entities present in the continuous aqueous phase may be bonded or absorbed.

The term “colloids possessing an apatite structure” is understood to mean, according to the invention, colloids of general formula:

Ca₁₀₋ₓ(HPO₄)ₓ(PO₄)₆₋ₓ(J)₂₋ₓ (I)

in which:

x is selected from 0, 1 or 2;

J is selected from OH⁻, CO₃²⁻, F⁻ and/or Cl⁻ and in which some phosphate ions (PO₄³⁻) or hydrogenphosphate ions (HPO₄²⁻) can be replaced by carbonate ions (CO₃²⁻);

and in which some Ca²⁺ cations can be replaced by Mⁿ⁺ metal cations of alkali metals, alkaline earth metals or lanthanide metals where n represents 1, 2 or 3, it being understood that the molar ratio of the Mⁿ⁺ cation to Ca²⁺, when Mⁿ⁺ is present, varies between 0.01:0.99 and 0.25:0.75, and that

the substitution of HPO₄²⁻ ions or of PO₄³⁻ ions by CO₃²⁻ ions, the incorporation of CO₃²⁻ ions as J and the substitution of Ca²⁺ cations by metal cations is carried out so as to satisfy the electronic balance, in particular with creation of gaps.

In a particularly preferred way, when Ca²⁺ is replaced by an alkali metal cation, the latter is Na⁺. When Ca²⁺ is replaced by an alkaline earth metal cation, the latter is Sr²⁺.

When Ca²⁺ is replaced by a lanthanide cation, the latter is preferably Eu³⁺, Eu²⁺, Dy³⁺ or Tb³⁺.

More generally, the term “lanthanide” is understood to mean the elements from the group consisting of yttrium and of the elements of the Periodic Table with an atomic number of between 57 and 71 inclusive.

The Periodic Table of the Elements to which reference is made in the present description is that published in the Supplement to the Bulletin de la Société Chimique de France, No. 1 (January 1966).

When x=0, the colloids are hydroxyapatite colloids. When x=1, the colloids are apatitic tricalcium phosphate colloids and, when x=2, the colloids are octocalcium phosphate colloids.

The expression “colloids possessing an apatite structure” also encompasses the colloids obtained by hydrolysis of the colloids of formula I above.

In the case of octocalcium phosphate, a colloid of formula Ca₈(HPO₄)_{2.5} (PO₄)_{3.5}OH_{0.5} is obtained after hydrolysis.

In the above formula, it is preferable for no Ca²⁺ cation to be replaced by an Mⁿ⁺ metal cation. However, when some Ca²⁺ cations are actually replaced by Mⁿ⁺ metal cations, then it is preferable for the Mⁿ⁺/Ca²⁺ molar ratio to vary between 0.02:0.98 and 0.15:0.85.

Colloids possessing an apatite structure are generally obtained by bringing into contact, in aqueous solution, a Ca²⁺ source and a PO₄³⁻ source in an appropriate pH range.

Conventionally, colloids possessing an apatite structure, the growth of which is difficult to control and limit, are obtained.

The kinetics of formation of the particles are often very high, so that it is difficult to halt the inorganic polycondensation at the stage of nanometric particles. Therefore, in fine, excessively large particles exhibiting a strong tendency to separate by settling are generally obtained.

The invention provides, according to a first of its aspects, a process which makes it possible to control the growth of colloids possessing an apatite structure and which results in stable colloidal dispersions composed of colloids of nanometric dimensions.

According to another of its aspects, the invention relates to stable aqueous colloidal dispersions, of colloids possessing an apatite structure, formed of relatively fine colloids of oblong shape with a (number-)average length of between 20 and 200 nm and with an equivalent aspect ratio (ratio of the (number-)average length to the equivalent diameter) of between 5 and 500.

More specifically, the invention relates to a stable aqueous colloidal dispersion of colloids possessing an apatite structure, exhibiting a pH of between 3.5 and 9.5, of oblong shape with a (number-)average length of between 20 and 200 nm and with an equivalent aspect ratio (ratio of the (number-)average length to the equivalent diameter) of between 5 and 500; and comprising, as stabilizing agent, a compound of formula I, a compound of formula II or a compound of formula III as defined below, optionally in the ionized form, or a mixture of these compounds, said colloids possessing an apatite structure having the formula:

Ca₁₀₋ₓ(HPO₄)ₓ(PO₄)₆₋ₓ(J)₂₋ₓ (IV)

in which:

x is selected from 0, 1 or 2;

J is selected from OH⁻, F⁻, CO₃²⁻ or Cl⁻;

and in which some phosphate ions (PO₄³⁻) or hydrogenphosphate ions (HPO₄²⁻) can be replaced by carbonate ions (CO₃²⁻);

and in which some Ca²⁺ can be replaced by Mⁿ⁺ metal cations of alkali metals, alkaline earth metals or lanthanide metals where n represents 1, 2 or 3, it being understood that the molar ratio of the Mⁿ⁺ cation to Ca²⁺, when Mⁿ⁺ is present, varies between 0.01:0.99 and 0.25:0.75, and that

the substitution of HPO₄²⁻ ions or of PO₄³⁻ ions by CO₃²⁻ ions, the incorporation of CO₃²⁻ ions as J and the substitution of Ca²⁺ cations by metal cations is carried out so as to satisfy the electronic balance;

the stabilizing agents of formula I being compounds of formula:

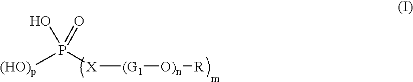

in which:

p represents 0 or 1;

m represents 2 when p represents 0 and m represents 1 when p represents 1;

n is an integer between 0 and 15, advantageously between 1 and 12, preferably between 2 and 6;

G₁ represents a (C₂-C₃)alkylene radical, preferably an ethylene radical;

X represents —O—; a bond; the divalent group —O—P(O)(OH)—X′— in which X′ is an oxygen atom or a bond;

or the divalent group —O—R₁₀—P(O)—X″— in which R₁₀ represents —(G₂—O)_{n′}— where G₂ is as defined for G₁ above and n′ is as defined for n above, preferably n′ is between 2 and 6, and X″ represents an oxygen atom or a single bond;

R represents a (C₁-C₂₀)alkyl, preferably (C₁-C₁₈)alkyl, radical or a (C₆-C₃₀)aryl radical,

said radical optionally being substituted;

it being understood that, when m represents 2, the two X-(G₁—O)ₙ—R groups are not necessarily identical and if, in one of these groups, G₁ represents —O—R₁₀—P(O)—X″— or —O—P(O)(OH)—X′—, the other X-(G₁—O)ₙ—R group does not comprise —O—R₁₀—P(O)—X″— group or —O—P(O) (OH)—X′— group;

the stabilizing agents of formula (II) being compounds of formula:

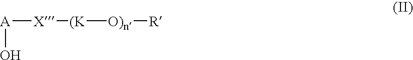

in which:

A represents a sulfonyl or sulfinyl group;

n′ is an integer between 0 and 15, advantageously between 1 and 12, preferably between 2 and 6;

R′ is as defined for R above:

X′″ represents —O— or a bond;

K represents a (C₂-C₃)alkylene radical, preferably an ethylene radical,

the stabilizing agents of formula (III) having the formula:

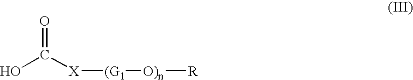

in which:

X, G₁, R and n are as defined above for the formula I.

In the context of the invention, the term “colloids of oblong shape” is understood to mean colloids of parallelepipedal shape (for example in the shape of a rod) or of acicular shape.

In the case of colloids of parallelepipedal shape, the equivalent diameter is the diameter which the corresponding colloid of acicular shape with the same (number-)average volume and with the same (number-)average length would have.

The equivalent diameter attributed to the cross section of the acicular colloid corresponds to the diameter of an average cross section.

The colloids of oblong shape are formed of colloids possessing a slightly aggregated apatite structure. Generally, the colloids of oblong shape exhibit a (number-)average length of between 20 and 200 nm and an equivalent diameter of between 0.01 and 50 nm, preferably between 0.01 and 20 nm.

The colloids possessing an apatite structure synthesized are preferably colloids of formula (I) in which x=0, better still colloids of formula: Ca₁₀(PO₄)₆(OH)₂.

More specifically, in the formula (I), it is preferable, for J to represent OH⁻ and/or F⁻. It is not necessary for all the OH⁻ ions to be replaced by F⁻ ions but only a portion of the OH⁻ ions may be replaced by F⁻ ions.

Likewise, when J is chosen from OH⁻, F⁻, CO₃²⁻ and Cl⁻, it is not necessary for all the J groups to be identical to one another.

The colloidal dispersion is stabilized by the action of a stabilizing agent. The stabilizing agent contributes not only to stabilizing the dispersion but also to controlling the growth of the colloids possessing an apatite structure during the preparation of the aqueous dispersion.

The ionized forms of the compounds of formula I, of formula II or of formula III can be obtained by the action of a base, preferably an inorganic base.

Mention may be made, as example of inorganic base, of bases of alkali metal hydroxide, alkaline earth metal hydroxide and ammonium hydroxide type.

The term “alkylene” is understood to mean a linear or branched C₁-C₁₈, preferably C₁-C₁₂, aliphatic hydrocarbonaceous chain.

The term “alkyl” is understood to mean a linear or branched C₁-C₁₈, better still C₁-C₁₂, aliphatic group.

Examples of alkyl radicals are the methyl, ethyl, propyl, isopropyl, butyl, isobutyl, t-butyl, pentyl, isopentyl, neopentyl, 2-methylbutyl, 1-ethylpropyl, hexyl, isohexyl, neohexyl, 1-methylpentyl, 3-methylpentyl, 1,1-dimethylbutyl, 1,3-dimethylbutyl, 2-ethylbutyl, 1-methyl-1-ethylpropyl, heptyl, 1-methylhexyl, 1-propylbutyl, 4,4-dimethylpentyl, octyl, 1-methylheptyl, 2-ethylhexyl, 5,5-dimethylhexyl, nonyl, decyl, 1-methylnonyl, 3,7-dimethyloctyl and 7,7-dimethyloctyl radicals.

More particularly, alkyl represents methyl, ethyl, propyl, isopropyl, butyl, t-butyl, pentyl, isopentyl, neopentyl, 2-methylbutyl, 1-ethylpropyl, hexyl, isohexyl, neohexyl, 1-methylpentyl, 3-methylpentyl, 1,1-dimethylbutyl, 1,3-dimethylbutyl, 2-ethylbutyl and 1-methyl-1-ethylpropyl.

The alkyl radical preferably comprises from 1 to 4 carbon atoms.

Examples of (C₆-C₃₀)aryl groups are in particular phenyl, naphthyl, anthryl and phenanthryl.

When R represents substituted (C₁-C₂₀)alkyl or substituted (C₁-C₁₈)alkyl, it is preferably substituted by (C₆-C₃₀)aryl. When R represents substituted (C₆-C₃₀)aryl, it is preferably substituted by (C₁-C₂₀)alkyl or (C₁-C₁₈)alkyl.

In the formulae (I), (II) and (III), it is preferable for n, respectively n′, to represent 3 or 5 and G₁, respectively K, to represent ethylene.

A particularly preferred subgroup of stabilizing agents is composed of the compounds of formula (V):

T₁—O—(CH₂—CH₂—O)ₙ—P(O)(OH)₂ (V)

optionally in the ionized form, in which formula:

T₁ is as defined for R in the formula (I); and

n is as defined in the formula (I).

Advantageously, n represents an integer from 2 to 12. A preferred meaning of aryl is phenyl and, when T₁ represents arylalkyl, T₁ is preferably phenylalkyl or else, when T₁ represents alkylaryl, T₁ preferably represents alkylphenyl.

More preferably still, T₁ represents hexyl, octyl, decyl, dodecyl, oleyl or nonylphenyl.

A second preferred subgroup of stabilizing agents is composed of the compounds of formula (VI):

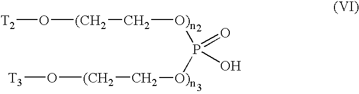

optionally in the ionized form, in which formula:

T₂ and T₃ are as defined for R in the formula (I); and

n₂ and n₃, which are identical or different, are as defined for n in the formula (I).

Advantageously, n₂ and n₃ are identical and comprise between 2 and 12.

Likewise, it is preferable for T₂ and T₃ to be identical. Here again, a preferred meaning of aryl is phenyl; a preferred meaning of arylalkyl is phenylalkyl; a preferred meaning of alkylaryl is alkylphenyl.

More preferably still, T₂ and T₃ are selected from hexyl, octyl, decyl, dodecyl, oleyl and nonylphenyl.

A third preferred subgroup of stabilizing agents is composed of a mixture in all proportions of compounds of formula V and of compounds of formula VI.

Mention may be made, as example of amphiphilic compounds of this type, of those sold under the Lubrophos® and Rhodafac® trademarks by Rhodia and in particular of the products below:

(C₈-C₁₀)alkyl polyoxyethylene ester phosphates: for example, Rhodafac® RA 600, in which the polyoxyethylene part is composed of 6 oxyethylene units;

tridecyl polyoxyethylene ester phosphate: for example, Rhodafac® RS 710, in which the polyoxyethylene part is composed of 10 oxyethylene units, or RS 410, in which the polyoxyethylene part is composed of 3 oxyethylene units;

oleyl/cetyl polyoxyethylene ester phosphate: for example, Rhodafac® PA 35, in which the polyoxyethylene part is composed of 5 oxyethylene units;

nonylphenyl polyoxyethylene ester phosphate: for example, Rhodafac® PA 17, in which the polyoxyethylene part is composed of 6 oxyethylene units;

(branched) nonyl polyoxyethylene ester phosphate: for example, Rhodafac® RE 610, in which the polyoxyethylene part is composed of 6 oxyethylene units.

The stabilizing agent is generally either present in the free form in the continuous medium of the colloidal dispersion or adsorbed at or bonded to the surface of the colloids or in ionic interaction with the Ca²⁺ ions present in the continuous phase of the dispersion.

When the stabilizing agent is in the free form in the dispersion, it is in the acid form or in the ionized form.

When the stabilizing agent is in interaction with the Ca²⁺ ion present in the continuous phase, it can form lamellar phase aggregates.

When the stabilizing agent is in interaction at the surface of the colloids, it is in strong electrostatic and/or complexing interaction with the inorganic ions present at the surface of the colloids. This strong bonding can be demonstrated by showing the presence of the stabilizing agent on the colloids which are recovered by ultracentrifuging the colloidal dispersions and are dried at ambient temperature for a time of more than 7 days. ¹H NMR spectroscopy on these colloids reveals lines corresponding to chemical shifts which can be assigned to the stabilizing agent.

The colloidal phase (composed of the colloids) predominantly possesses an apatite structure as defined above. Advantageously, the apatite structure represent more than 50% by weight of the colloidal phase, preferably more than 75% by weight, better still more than 80%, for example more than 85% by weight.

The colloidal phase can additionally comprise other structures, such as Ca(H₂PO₄)₂; CaHPO₄; CaHPO₄.2H₂O, or other amorphous phase based on calcium and on PO₄³⁻, HPO₄²⁻, H₂PO₄⁻ or OH⁻.

According to a preferred embodiment of the invention, the molar ratio of the total calcium present in the colloidal phase to the total phosphorus present in the colloidal phase varies between 0.8 and 1.7, better still between 1.4 and 1.7.

Preferably, the molar ratio of the stabilizing agent to the calcium in the colloidal phase varies between 0.02 and 2, preferably between 0.02 and 1.0, better still between 0.05 and 0.8.

In a particularly preferred way, the colloidal phase comprises from 80 to 100% of the total calcium, preferably from 90 to 100%, better still from 95 to 100%.

The concentration of calcium in the dispersion can be easily adjusted, according to the invention, by removing a portion of the continuous aqueous phase.

The removal of a portion of the aqueous phase can be carried out by ultrafiltration.

However, preferably, the colloidal dispersion of the invention exhibits a concentration of calcium in the form of colloids possessing an apatite structure of greater than 0.25M, preferably of greater than 0.5M, advantageously of greater than 1M, it being possible for this concentration to reach 5M.

Advantageously, the colloidal phase comprises from 60 to 100% of the total phosphorus (total PO₄³⁻, HPO₄²⁻ and H₂PO₄⁻ ions), preferably from 80 to 100%, preferably from 90 to 100%, better still from 95 to 100%, by weight.

According to a preferred form of the invention, the pH of the colloidal dispersion of the invention varies between 6 and 9.5, better still between 6.5 and 9.

According to another of its aspects, the invention relates to a process for the preparation of a stable aqueous colloidal dispersion comprising the stages consisting in:

a) bringing into contact, in aqueous solution, a source of Ca cations and a source of PO₄³⁻ anions and a stabilizing agent selected from a compound of formula I, a compound of formula II and a compound of formula III, the formulae I, II and III being as defined above or representing a salt of one of these compounds with an acid or a base and one of their mixtures, at a pH of between 3.5 and 9.5, the respective amounts of the source of Ca 2+ and of the source of PO₄³⁻ anions being such that the Ca²⁺/P molar ratio varies between 0.1 and 3, preferably between 0.2 and 2, the amount of stabilizing agent being such that the stabilizing agent/Ca molar ratio varies between 0.05 and 0.5, preferably between 0.08 and 0.4;

b) leaving the solution thus obtained to mature at a temperature of between 20 and 150° C. until a colloidal dispersion is obtained.

The term “source of Ca²⁺ cations” is understood to mean a compound capable of releasing Ca²⁺ ions in aqueous solution.

The term “source of PO₄³⁻ anions” is understood to mean a compound capable of releasing PO₄³⁻ ions in aqueous solution.

Examples of source of Ca²⁺ cations are calcium hydroxide, calcium oxides or water-soluble calcium salts.

Examples of calcium salts are the salts having, as anion, PF₆⁻, PCl₆⁻, BF₄⁻, BCl₄⁻, SbF₆⁻, BPh₄⁻, ClO₄⁻, CF₃SO₃⁻ and more generally the carboxylates derived from C₂-C₁₀ alkylcarboxylic acids and in particular the acetate. Other salts are calcium halides, calcium hydrogencarbonate and calcium nitrate. Among these salts, those which can be used in the context of the invention are those exhibiting a sufficient solubility in water to provide the desired concentration of Ca²⁺ in the aqueous phase.

In a particularly preferred way, the source of Ca²⁺ cations is selected from calcium hydroxide, calcium chloride, calcium fluoride, calcium nitrate and calcium hydrogencarbonate.

By way of example, the source of PO₄³⁻ anions is the salt of a PO₄³⁻ anion, the salt of an HPO₄²⁻ anion or the salt of an H₂PO₄⁻ anion, such as an ammonium salt or an alkali metal salt.

Other sources of PO₄³⁻ are the salts of the anions of oligomeric phosphate type, such as the salts of the polyphosphates (or catena-polyphosphate) of general formula:

[O(PO₃)ₙ]⁽ⁿ⁺²⁾^{⁻}

in which n varies from 2 to 10 (and in particular the salts of tripolyphosphate type) or also the salts of the trimetaphosphate anion (PO₃)₃³⁻ or the salts of the pyrophosphate anion (P₂O₇)⁴⁻.

The use of the acid H₃PO₄ as source of PO₄³⁻ anions can also be envisaged.

Advantageously, when a calcium oxide or a calcium hydroxide is used as source of Ca²⁺, it is desirable to select phosphoric acid as source of PO₄³⁻.

The following stage consists in mixing the two aqueous solutions, this mixing being carried out conventionally with stirring.

These two sources have to be brought together under highly specific pH conditions in order to result in the formation of colloids possessing the desired apatite structure: generally, a pH of between 3.5 and 10.5, preferably between 6 and 9.5, better still between 5 and 9, is highly suitable.

Thus, preferably, the pH of the two dispersions is preadjusted before mixing.

After bringing the two sources together in an aqueous medium, it may thus prove to be necessary to again adjust the pH of the aqueous medium by addition to this medium of an acid or of a base, preferably an inorganic acid or base.

The bases and acids which can be used are those generally used in the art.

Mention may be made, as bases which can be used, of NH₄OH, KOH, NaOH, NaHCO₃, Na₂CO₃, KHCO₃ and K₂CO₃.

Use will preferably be made of NH₄OH or NaOH.

Examples of acids which can be used are in particular HCl, H₂SO₄, H₃PO₄ or HNO₃. Use will preferably be made of HNO₃.

A buffer which operates within the desired range can be used to adjust the pH. Use is preferably made of a buffer providing a pH of 6.5 to 9.

Mention may be made, as particularly preferred example, of a buffer composed of an aqueous solution of potassium dihydrogenphosphate (0.025M) and of sodium hydrogenphosphate (0.025M), which provides a pH of 6.86 at 25° C.

The sources can be brought into contact in an aqueous medium in any way.

Preferably, it is recommended to prepare, in a first step, an aqueous solution of the source of Ca²⁺, on the one hand, and an aqueous solution of the source of PO₄³⁻, on the other hand. The relative proportions of the compounds used respectively as source of Ca²⁺ and of PO₄³⁻ are calculated so that the Ca/P molar ratio is between 0.1 and 3, preferably between 0.2 and 2.

The Ca/P molar ratio takes into account all the Ca²⁺ cations introduced and all the phosphorus introduced into the solution, whether the phosphorus is in the H₃PO₄, H₂PO₄³⁻, HPO₄²⁻ or PO₄³⁻ form.

The stabilizing agent is then added, either to the aqueous Ca²⁺ solution, or to the aqueous PO₄³⁻ solution, or to both aqueous solutions, in which case the respective proportion of stabilizing agent added to each solution can take any value.

The amount of stabilizing agent to be added in total is defined so that the stabilizing agent/Ca molar ratio varies between 0.05 and 0.5, preferably between 0.08 and 0.4.

The amount of stabilizing agent used changes the dimensions of the colloids finally obtained.

Advantageously, after mixing, the concentration of Ca²⁺ cations in the solution is between 0.1M and 1M, preferably between 0.1M and 0.5M; and the concentration of total PO₄³⁻, HPO₄²⁻ and H₂PO₄⁻ ions varies between 0.05M and 2M, preferably between 0.15M and 1M.

The source of Ca²⁺ and the source of PO₄³⁻ are generally brought into contact at ambient temperature, for example between 15 and 30° C.

For the purpose of preparing colloids in which some of the calcium cations are replaced by metal cations, it is necessary to add one or more sources of said metal cations to the reaction medium. Appropriate sources are composed of the hydroxides of these metals or salts of these metals, such as the halides or nitrates.

In the case where the metal cation is the cation of a lanthanide, it is preferable to add a salt of said lanthanide to the reaction solution, such as a chloride or a nitrate. This salt will be added, for example, to the solution of the source of calcium before it is mixed with the source of PO₄³⁻.

Stage b) of the process of the invention is a maturing stage during which the mixture of the two solutions is left standing or stirring, the time necessary to observe the formation of colloids.

This maturing stage can be carried out at ambient temperature (15-30° C.) or at a higher temperature, namely up to 150° C. Thus, generally, the temperature is set at this stage between 15 and 150° C., better still between 40 and 100° C.

The maturing stage is preferably carried out in a closed chamber.

The dispersion, conditioned in a closed chamber, can be placed directly in an oven brought beforehand to the set temperature or can be subjected to a temperature gradient up to the set temperature, the rate of temperature rise preferably varying between 0.1° C./min and 10° C./min.

According to another embodiment of the invention, the maturing is carried out at various temperatures.

Preferably, a first maturing phase is carried out at a first temperature of between 20 and 95° C. and a second maturing phase is carried out at a second temperature, said second temperature also being between 20 and 95° C.

Advantageously, said second temperature is less than said first temperature.

The maturing time varies according to the operating conditions and more particularly the temperature. Usually, the maturing time varies between 10 min and 24 hours, for example between 30 min and 18 hours.

The continuous phase of the colloidal dispersion can comprise various entities, such as NH₄⁺, Na⁺, K⁺, Cl⁻, NO₃⁻ and SO₄²⁻. These ions originate either from the sources of calcium and of PO₄³⁻ or from the inorganic acids and bases used for the pH adjustments.

The continuous phase of the colloidal dispersion can also comprise stabilizing agents, in the neutral form or in the ionized form, not in interaction with the surface of the colloids, that is to say completely free, or else in interaction with the Ca²⁺ ions present in the continuous phase.

It is difficult to avoid the presence of various calcium or phosphorus entities in the continuous aqueous phase or beside the colloids possessing an apatite structure and the presence of stabilizing agent, so that it may be necessary to carry out a purification, for example by washing the dispersion.

This washing operation can be carried out in a way which is conventional per se, by ultrafiltration or dialysis.

Ultrafiltration can be carried out in particular under air or under an atmosphere of air and nitrogen or under nitrogen. It is preferably carried out with water having a pH adjusted to the pH of the dispersion.

If appropriate, the dispersion can then also be concentrated by removing a portion of the continuous phase. The most appropriate technique for doing this is the ultrafiltration technique.

A postadjustment of the pH can also be carried out after the washing operation and the operation of concentrating by ultrafiltration. This final pH can advantageously be between 6 and 8.5.

The size of the colloids can be determined by photometric counting from an HRTEM (High Resolution Transmission Electron Microscopy) analysis. The structure of the colloids and in particular their more or less significant degree of aggregation can be determined by cryo-transmission electron microscopy by following the Dubochet method.

The (number-)average length of the colloids of oblong shape varies between 20 and 200 nm and their equivalent aspect ratio (ratio of the (number-)average length to the equivalent diameter) varies between 5 and 500.

One of the advantages of the invention is the low aggregation of the colloidal particles with one another.

The colloidal dispersions of the invention can be used in many applications, as they are or after isolating and arranging and cohering the colloids possessing an apatite structure to form, for example, porous materials.

The colloidal dispersions of the invention can also be used after preparation of an emulsion by addition of an oily phase.

Applicational examples of the colloids and porous materials are the separation and purification of proteins, use in prostheses and use in prolonged release systems.

In the pharmaceutical field, the hydroxyapatite colloids obtained can be used in the treatment of osteoporosis, cramp, colitis, bone fractures or insomnia and in dental hygiene.

The hydroxyapatite colloids can also be used in the preparation of hydroxyapatite films, of absorbant materials with a high specific surface and with a high pore volume, of encapsulation materials and of catalytic materials, and also in the field of luminescence.

The colloids of the aqueous dispersions of the invention can be isolated simply by ultracentrifuging. These colloids can exhibit, bonded to or absorbed at their surface, a certain amount of stabilizing agent. The amount of stabilizing agent present can be determined by chemical quantitative determination. The molar ratio of the stabilizing agent to the calcium of the colloid generally varies between 0.02 and 2, preferably between 0.05 and 0.8.

The percentage by mass of Ca in the colloids is determined in the following way from colloids isolated by centrifuging and dried at ambient temperature for 7 days.

The dried colloids are dissolved by HNO₃/HF/H₂O₂ using microwave radiation. Quantitative determination of Ca is then carried out by inductively coupled plasma/atomic emission spectroscopy (ICP/AES) on a Jobin Yvon Ultima device. The principle is to excite the atoms in an argon plasma, with emission of photons of different wavelengths. A grating spectrometer makes it possible to separate the wavelengths and detection is carried out using a photomultiplier. The percentage by mass of carbon present in the colloids recovered by ultracentrifuging and dried at ambient temperature for 7 days is determined conventionally by elemental microanalysis using a Leco CS-044 device. The product is oxidized in the presence of catalysts in an induction furnace while flushing with oxygen. The CO₂ peaks are detected and integrated by infrared spectroscopy.

The determination is thus carried out, from these analyses, of an experimental C/Ca ratio by mass and, by calculation, of the “stabilizing agent/Ca” molar ratio of the colloids.

According to another of its aspects, the invention relates to water-redispersible colloids possessing an apatite structure which can be obtained by carrying out the stages consisting in:

a—preparing an aqueous colloidal dispersion by employing the process of the invention as described above;

b—isolating the colloids from the aqueous colloidal dispersion obtained in the preceding stage.

The colloids can be isolated from the colloidal dispersion in a way known per se, for example by simple evaporation at ambient temperature of the continuous phase or by ultracentrifuging. The colloids isolated after ultracentrifuging or evaporating the continuous phase exist in the form of a paste or of an optionally pulverulent solid.

The continuous phase can be evaporated by employing conventional techniques known to a person skilled in the art, for example at ambient temperature or at temperatures of greater than 100° C.

The colloids thus obtained can be redispersed in water.

According to a preferred embodiment of the invention, the resulting dispersion exhibits a concentration of calcium in the form of colloids possessing an apatite structure of greater than 0.25M, preferably of greater than 0.5M, advantageously of greater than 1M.

Preferably, the molar ratio of the calcium to the phosphorus also varies in the colloids between 0.8 and 1.7.

The invention is described more specifically below with reference to specific embodiments of the invention.

Each of the examples below illustrates the preparation of aqueous dispersions of hydroxyapatite colloids.

In the following, M denotes the molecular mass.

### EXAMPLE 1

A solution comprising the Ca²⁺ ion and an amphiphilic agent is prepared by addition of 13.2 g of CaCl₂.2H₂O (M=147 g), i.e. 0.09 mol, to be dissolved in 250 cm³ of demineralized water. 18.12 g of amphiphilic agent Rhodafac PA 35 (M=806 g), i.e. 0.0225 mol, are subsequently added with stirring at ambient temperature, and enough demineralized water is added to bring the volume to 270 cm³. The solution obtained is then brought to pH 7 with a 1M aqueous NH₄OH solution.

An ammonium phosphate solution is prepared with 23.76 g of diammonium hydrogenphosphate (M=132 g), i.e. 0.18 mol. Enough demineralized water is added to bring the volume to 60 cm³ and the solution is stirred. The pH is adjusted to 7 with nitric acid.

The phosphate solution is added to the calcium solution with stirring at ambient temperature. The pH is readjusted to 7 with a 1M aqueous NH₄OH solution. The mixture has a Ca/P molar ratio of 0.5 and a PA 35/Ca molar ratio of 0.25.

The mixture is stirred for one hour, transferred to a hermetically-sealed bottle and then subjected to a heat treatment by maintaining in an oven brought beforehand to a temperature of 50° C. The heat treatment lasts 16 hours. A colloidal dispersion is obtained.

The colloidal dispersion is washed by ultrafiltration by passing over a 3 kD membrane. Washing is carried out with a volume of demineralized water equal to four times the volume of dispersion. Quantitative determination of the ultrafiltered dispersion indicates 6.55 g/l of Ca and a (Ca:P) molar ratio=0.94 and a (PA35:Ca) molar ratio=0.08.

### EXAMPLE 2

A solution comprising the Ca²⁺ ion and an amphiphilic agent is prepared by addition of 13.2 g of CaCl₂.2H₂O (M=147 g), i.e. 0.09 mol, to be dissolved in 250 cm³ of demineralized water. 7.15 g of amphiphilic agent Rhodafac PA 35 (M=806 g), i.e. 0.009 mol, are subsequently added with stirring at ambient temperature, and enough demineralized water is added to bring the volume to 270 cm³. The solution obtained is then brought to pH 8.5 with a 1M aqueous NH₄OH solution.

An ammonium phosphate solution is prepared with 23.76 g of diammonium hydrogenphosphate (M=132 g), i.e. 0.18 mol. Enough demineralized water is added to bring the volume to 60 cm³ and the solution is stirred. The pH is adjusted to 8.5 with nitric acid.

The phosphate solution is added to the calcium solution with stirring at ambient temperature. A decrease in the pH is observed. The pH is readjusted to 8.5 with 1M aqueous NH₄OH solution. The mixture has a (Ca/P) molar ratio=0.5 and a (PA 35/Ca) molar ratio=0.1.

The mixture is stirred for one hour, transferred to a hermetically-sealed bottle and then subjected to a heat treatment by maintaining in an oven brought beforehand to a temperature of 95° C. The heat treatment lasts 16 hours. A colloidal dispersion is obtained.

The colloidal dispersion is washed by ultrafiltration by passing over a 3 kD membrane. Washing is carried out with a volume of demineralized water equal to 4 times the volume of dispersion.

Colloids possessing anisotropic morphology are observed by cryo-transmission electron microscopy. The objects are rod-shaped with an average length of approximately 50 nm and with an equivalent diameter of approximately 10 nm.

After ultracentrifuging an aliquot of the ultrafiltered dispersion at 50 000 rev/min for 4 hours, a pellet is collected and is dried at ambient temperature.

Single-pulse and crossed polarization magic angle spinning ³¹P NMR spectroscopic examination of the dried pellet reveals a major peak corresponding to a chemical shift of approximately 3 ppm assigned to hydroxyapatite. This hydroxyapatite phase corresponds approximately to 80% of the product. A peak at approximately 0 ppm corresponding to an unidentified phase is also observed. Single-pulse proton NMR spectroscopy reveals protons belonging to organic chains of the amphiphilic agent used. X-ray diffraction carried out on the pellet reveals a poorly defined line which can be assigned to hydroxyapatite.

### EXAMPLE 3

A solution comprising the Ca²⁺ ion and an amphiphilic agent is prepared by addition of 13.2 g of CaCl₂.2H₂O (M=147 g), i.e. 0.09 mol, to be dissolved in 250 cm³ of demineralized water. 26.78 g of amphiphilic agent Rhodafac PA 35 (M=806 g), i.e. 0.033 mol, are subsequently added with stirring at ambient temperature, and enough demineralized water is added to bring the volume to 270 cm³. The solution obtained is then brought to pH 8.5 with a 1M aqueous NH₄OH solution.

An ammonium phosphate solution is prepared with 11.88 g of diammonium hydrogenphosphate (M=132 g), i.e. 0.09 mol. Enough demineralized water is added to bring the volume to 60 cm³ and the solution is stirred. The pH is adjusted to 8.5 with nitric acid.

The phosphate solution is added to the calcium solution with stirring at ambient temperature. A decrease in the pH is observed. The pH is readjusted to 8.5 with 1M aqueous NH₄OH solution. The mixture has a (Ca/P) molar ratio=1.0 and a (PA 35/Ca) molar ratio=0.37.

The mixture is stirred for one hour, transferred to a hermetically-sealed bottle and then subjected to a heat treatment by maintaining in an oven brought beforehand to a temperature of 50° C. The heat treatment lasts 16 hours. A colloidal dispersion is obtained. The colloidal dispersion is washed by ultrafiltration by passing over a 3 kD membrane. Washing is carried out with a volume of demineralized water equal to 4 times the volume of dispersion.

After ultracentrifuging at 50 000 rev/min for 4 hours, a pellet is collected and is dried at ambient temperature.

Single-pulse and crossed polarization magic angle spinning ³¹P NMR spectroscopy reveals a major peak corresponding to a chemical shift of approximately 3 ppm assigned to hydroxyapatite. This hydroxyapatite phase corresponds approximately to 80% of the product. A peak at approximately 0 ppm is also observed, assigned to DCPA (anhydrous dicalcium phosphate).

Single-pulse proton NMR spectroscopy reveals protons belonging to organic chains of the amphiphilic agent used.

### EXAMPLE 4

A solution comprising the Ca²⁺ ion and an amphiphilic agent is prepared by addition of 44 g of CaCl₂.2H₂O (M=147 g), i.e. 0.3 mol, to be dissolved in 833 cm³ of demineralized water. 89.2 g of amphiphilic agent Rhodafac PA 35 (M=806 g), i.e. 0.11 mol, are subsequently added with stirring at ambient temperature, and enough demineralized water is added to bring the volume to 900 cm³. The solution obtained is then brought to pH 8.0 with a 1M aqueous NH₄OH solution.

An ammonium phosphate solution is prepared with 79.2 g of diammonium hydrogenphosphate (M=132 g), i.e. 0.6 mol. Enough demineralized water is added to bring the volume to 200 cm³ and the solution is stirred. The pH is adjusted to 8.0 with nitric acid.

The phosphate solution is added to the calcium solution with stirring at ambient temperature. A decrease in the pH is observed. The pH is readjusted to 8.0 with 1M aqueous NH₄OH solution. The mixture has a (Ca/P) molar ratio=0.5 and a (PA 35/Ca) molar ratio=0.37.

The mixture is stirred for one hour, transferred to a hermetically-sealed bottle and then subjected to a heat treatment by maintaining in an oven brought beforehand to a temperature of 50° C. The heat treatment lasts 16 hours. A colloidal dispersion is obtained.

The colloidal dispersion is washed by ultrafiltration by passing over a 3 kD membrane. Washing is carried out with a volume of demineralized water equal to 4 times the volume of dispersion.

Cryo-transmission electron microscopy reveals objects possessing anisotropic morphology of rod type. The average length of the rods is approximately 60 nm and the equivalent diameter is approximately 5 nm.

Electrophoretic measurements show that, at pH 8, the surface charge is negative and that the zeta potential is equal to pH 2.

After ultracentrifuging at 50 000 rev/min for 4 hours, a pellet is collected and is dried at ambient temperature.

Single-pulse and crossed polarization magic angle spinning ³¹P NMR spectroscopy reveals a major peak corresponding to a chemical shift of approximately 3 ppm assigned to hydroxyapatite. This hydroxyapatite phase corresponds approximately to 80% of the product. A peak at approximately 0 ppm, corresponding to an unidentified phase, is also observed.

Single-pulse proton NMR spectroscopy reveals protons belonging to organic chains of the amphiphilic agent used.

An aliquot of the dispersion is dried at ambient temperature for several days. The dried product is then taken up in a volume of water up to a volume corresponding to the volume of the initial dispersion before drying. The product is redispersible and a colloidal dispersion is again obtained.

### EXAMPLE 5

A solution comprising the Ca²⁺ ion and an amphiphilic agent is prepared by addition of 13.2 g of CaCl₂.2H₂O (M=147 g), i.e. 0.09 mol, to be dissolved in 250 cm³ of demineralized water. 26.78 g of amphiphilic agent Rhodafac PA 35 (M=806 g), i.e. 0.033 mol, are subsequently added with stirring at ambient temperature, and enough demineralized water is added to bring the volume to 270 cm³. The solution obtained is then brought to pH 8.5 with a 1M aqueous NH₄OH solution.

An ammonium phosphate solution is prepared with 7.92 g of diammonium hydrogenphosphate (M=132 g), i.e. 0.06 mol. Enough demineralized water is added to bring the volume to 60 cm³ and the solution is stirred. The pH is adjusted to 8.5 with nitric acid.

The phosphate solution is added to the calcium solution with stirring at ambient temperature. A decrease in the pH is observed. The pH is readjusted to 8.5 with 1M aqueous NH₄OH solution. The mixture has a (Ca/P) molar ratio=1.5 and a (PA 35/Ca) molar ratio=0.37.

The mixture is stirred for one hour, transferred to a hermetically-sealed bottle and then subjected to a heat treatment by maintaining in an oven brought beforehand to a temperature of 95° C. The heat treatment lasts 16 hours. A colloidal dispersion is obtained.

The colloidal dispersion is washed by ultrafiltration by passing over a 3 kD membrane. Washing is carried out with a volume of demineralized water equal to 4 times the volume of dispersion.

After ultracentrifuging at 50 000 rev/min for 4 hours, a pellet is collected and is dried at ambient temperature.

Single-pulse and crossed polarization magic angle spinning ³¹P NMR spectroscopy reveals a major peak corresponding to a chemical shift of approximately 3 ppm assigned to hydroxyapatite. This hydroxyapatite phase corresponds approximately to 80% of the product. A peak at approximately 0 ppm, corresponding to an unidentified phase, is also observed.

Single-pulse proton NMR spectroscopy reveals protons belonging to organic chains of the amphiphilic agent used.

### EXAMPLE 6

A solution A comprising the Ca²⁺ ion and an amphiphilic agent is prepared by addition of 13.2 g of CaCl₂.2H₂O (M=147 g), i.e. 0.09 mol, to be dissolved in 200 cm³ of demineralized water. 16.5 g of amphiphilic agent Rhodafac RS 410 (M=569 g), i.e. 0.029 mol, are subsequently added with stirring at ambient temperature and enough demineralized water is added to bring the volume to 220 Cm³. The solution obtained is then brought to pH 8.5 with a 1M aqueous NH₄OH solution. Enough demineralized water is added to bring the volume to 270 Cm³.

An ammonium phosphate solution B is prepared with 11.88 g of diammonium hydrogenphosphate (M=132 g), i.e. 0.09 mol. Enough demineralized water is added to bring the volume to 40 cm³ and the solution is stirred. The pH is adjusted to 8.5 with a 1N aqueous nitric acid solution. Enough demineralized water is added to bring the volume to 60 cm³ and the solution is stirred.

The 60 cm³ of the phosphate solution B thus prepared are added to an aliquot of 90 cm³ of the calcium solution A with stirring at ambient temperature. A reduction in the pH is observed. The pH is readjusted to 8.5 with a 1M aqueous NH₄OH solution. The mixture has a (Ca/P) molar ratio=0.33 and a (PA 35/Ca) molar ratio=0.32.

The mixture is stirred for one hour, transferred to a hermetically-sealed bottle and then subjected to a heat treatment by maintaining in an oven brought beforehand to a temperature of 50° C. The heat treatment lasts 16 hours. A colloidal dispersion is obtained.

### EXAMPLE 7

A solution A is prepared by adding 0.44 g of CaCl₂.2H₂O (i.e. 3 millimol) to 30 cm³ of water. 0.780 g of Rhodafac PA 35 (i.e. 1 millimol) is added. The pH is equal to 2. The solution is adjusted to pH 7 with a 1M aqueous NH₄OH solution.

A solution B is prepared with 20 Cm³ of a 0.25M aqueous (NH₄)₂HPO₄ solution (i.e. 5 millimol) preadjusted to pH 7.

The solution A is added to the solution B instantaneously at ambient temperature and with stirring, and the volume is made up to 60 Cm³ with distilled water with stirring, so as to obtain Ca²⁺=0.05M.

The (PA35:Ca) molar ratio=(0.32:1).

The (Ca:P) molar ratio=(1:1.66).

The temperature is brought to 95° C. for 16 hours.

A colloidal dispersion is obtained.

Cryo-TEM reveals completely separate acicular colloids with an average length of 150 nm and a diameter of 5 nm.

According to a preferred embodiment of the invention, the colloidal dispersion is prepared by the two-stage process of the invention, in which, during the first stage, the source of Ca²⁺ and the source of PO₄³⁻ are brought into contact by mixing an aqueous solution of a source of PO₄³⁻ exhibiting a pH between 6.5 and 9 with an aqueous solution of a source of Ca²⁺ comprising the stabilizing agent and exhibiting a pH between 6.5 and 9.

1. A stable aqueous colloidal dispersion of colloids possessing an apatite structure, exhibiting a pH of between 3.5 and 9.5, of oblong shape with an average length of between 20 and 200 nm and with an equivalent aspect ratio (ratio of the average length to the equivalent diameter) of between 5 and 500, and comprising, as stabilizing agent, a compound of formula I, a compound of formula II or a compound of formula III as defined below, optionally in the ionized form, or a mixture of these compounds, said colloids possessing an apatite structure having the formula:
Ca₁₀₋ₓ(HPO₄)ₓ(PO₄)₆₋ₓ(J)₂₋ₓ (iv)
in which:
x is selected from 0, 1 or 2;
J is selected from OH⁻, F⁻, CO₃²⁻ or Cl⁻;
and in which some phosphate ions (PO₄³⁻) or hydrogenphosphate ions (HPO₄²⁻) can be replaced by carbonate ions (CO₃²⁻);
and in which some Ca²⁺ cations can be replaced by Mⁿ⁺ metal cations of alkali metals, alkaline earth metals or lanthanide metals where n represents 1, 2 or 3, it being understood that the molar ratio of the Mⁿ⁺ cation to Ca²⁺, when Mⁿ⁺ is present, varies between 0.01:0.99 and 0.25:0.75, and that the substitution of HPO₄²⁻ ions or of PO₄³⁻ ions by CO₃²-ions, the incorporation of CO₃²⁻ ions as J and the substitution of Ca²⁺ cations by metal cations is carried out so as to satisfy the electronic balance;
the stabilizing agents of formula (I) being compounds of formula: 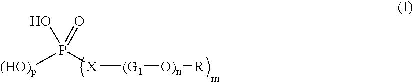
in which:
p represents 0 or 1;
m represents 2 when p represents 0 and m represents 1 when p represents 1;
n is an integer between 0 and 15, advantageously between 1 and 12, preferably between 2 and 6;
G₁ represents a (C₂-C₃)alkylene radical, preferably an ethylene radical;
X represents —O—; a bond; the divalent group —O—P(O)(OH)—X′— in which X′ is an oxygen atom or a bond;
or the divalent group —O—R₁₀-P(O)—X″— in which R₁₀ represents —(G₂—O)ₙ— where G₂ is as defined for G₁ above and n′ is as defined for n above, preferably n′ is between 2 and 6, and X″ represents an oxygen atom or a single bond;
R represents a (C₁-C₂₀)alkyl radical or a (C₆-C₃₀)aryl radical, said radical optionally being substituted and representing, for example, (C₁-C₂₀) alkyl (C₆-C₃₀) aryl or (C₆-C₃₀) aryl-(C₁-C₂₀) alkyl,
it being understood that, when m represents 2, the two X-(G₁—O)ₙ—R groups are not necessarily identical and if, in one of these groups, G₁ represents —O—R₁₀-P(O)—X″— or —O—P(O) (OH)—X′—, the other X-(G₁—O)ₙ—R group does not comprise —O—R₁₀—P(O)—X′— group or —O—P(O) (OH)—X′— group;
the stabilizing agents of formula (II) being compounds of formula: 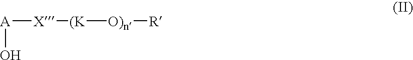
in which:
A represents sulfonyl or sulfinyl;
n′ is an integer between 0 and 15, advantageously between 1 and 12, preferably between 2 and 6;
R′ is as defined for R above:
X′″ represents —O— or a bond;
K represents a (C₂-C₃)alkylene radical, preferably an ethylene radical,
the stabilizing agents of formula (III) having the formula: 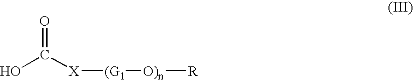
in which:
X, G₁, R and n are as defined above for the formula I.

2. The colloidal dispersion as claimed in claim 1, characterized in that x represents 0.

3. The colloidal dispersion as claimed in claim 1, formed of apatite colloids of formula Ca₁₀(PO₄)₆(OH)₂.

4. The colloidal dispersion as claimed in any one of claims 1 to 3, which exhibits a concentration of calcium in the form of colloids possessing an apatite structure of greater than 0.25M, preferably of greater than 0.5M.

5. The colloidal dispersion as claimed in any one of claims 1 to 4, characterized in that the stabilizing agent is a compound of formula (V):
T₁-O—(CH₂—CH₂—O)ₙ—P(O)(OH)₂ (V)
optionally in the ionized form, in which formula T₁ is as defined for R in claim 1 and n is as defined in claim 1.

6. The colloidal dispersion as claimed in any one of claims 1 to 4, characterized in that the stabilizing agent is a compound of formula (VI): 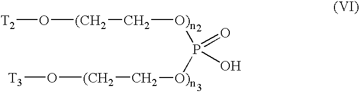
optionally in the ionized form, in which formula T₂ and T₃, which are identical or different, are as defined for R in claim 1 and n₂ and n₃, which are identical or different, are as defined for n in claim 1.

7. The colloidal dispersion as claimed in any one of claims 1 to 4, characterized in that the stabilizing agent is composed of a compound of formula (V) and of a compound of formula (VI).

8. The colloidal dispersion as claimed in any one of claims 1 to 7, in which the molar ratio of the stabilizing agent to the calcium in the colloidal phase varies between 0.02 and 2, preferably between 0.05 and 0.8.

9. A process for the preparation of a stable aqueous colloidal dispersion comprising the stages consisting in:
a) bringing into contact, in aqueous solution, a source of Ca²⁺ cations and a source of PO₄³-anions and a stabilizing agent selected from a compound of formula I, a compound of formula II and a compound of formula III, the formulae I, II and III being as defined in claim 1 or representing a salt of one of these compounds with an acid or a base and one of their mixtures, at a pH of between 3.5 and 9.5, the amount of source of Ca²⁺ and of PO₄₃— anions being such that the Ca²⁺/P molar ratio varies between 0.1 and 3, preferably between 0.2 and 2, the amount of stabilizing agent being such that the stabilizing agent/Ca molar ratio varies between 0.05 and 0.5, preferably between 0.08 and 0.4;
b) leaving the solution thus obtained to mature at a temperature of between 20 and 150° C. until a colloidal dispersion is obtained.

10. The process as claimed in claim 9, characterized in that the temperature is maintained between 40 and 100° C. in stage b).

11. The process as claimed in either one of claims 9 and 10, characterized in that the solution obtained on conclusion of stage b) is concentrated by ultrafiltration.

12. The process as claimed in any one of claims 9 to 11, characterized in that, in stage a), the source of Ca²⁺ and the source of PO₄³⁻ are brought into contact by mixing an aqueous solution of a source of PO₄³⁻ exhibiting a pH between 6.5 and 9 with an aqueous solution of a source of Ca²⁺ comprising the stabilizing agent and exhibiting a pH between 6.5 and 9.

13. The process as claimed in any one of claims 9 to 12, characterized in that the source of calcium is selected from calcium nitrate, calcium chloride, calcium fluoride, calcium hydrogencarbonate and calcium hydroxide.

14. The process as claimed in any one of claims 9 to 13, characterized in that the source of PO₄₃— is selected from the salts of the PO₄₃—, H₂PO₄— or HPO₄²-anions, such as the alkali metal salts and the ammonium salts.

15. The process as claimed in any one of claims 9 to 14, characterized in that the source of Ca²⁺ cations is brought into contact with the source of PO₄³⁻ anions at a pH of between 6 and 9.5, better still between 6.5 and 9.

16. The process as claimed in any one of claims 9 to 15, characterized in that, after bringing into contact, the concentration of calcium is between 0.1M and 1M, preferably between 0.1M and 0.5M.

17. The process as claimed in any one of claims 9 to 16, characterized in that, after bringing into contact, the concentration of total PO₄³, HPO₄²⁻ and H₂PO₄ ions varies between 0.05 and 2M, preferably between 0.15M and 1M.

18. A water-redispersible colloid possessing an apatite structure which can be obtained by carrying out the stages consisting in:
a—preparing an aqueous colloidal dispersion by employing the process as claimed in any one of claims 9 to 17;
b—isolating the colloid from the colloidal dispersion resulting from stage a).
